(19) United States
(12) Patent Application Publication
(10) Pub. No.: US 2011/0281042 A1
(43) Pub. Date: Nov. 17, 2011

(54) SURFACE ADDITIVES FOR WHITENESS IMPROVEMENTS TO REVERSE WHITENESS LOSS DUE TO CALCIUM CHLORIDE

(75) Inventor: Martha Patricia Wild, Decatur, AL (US)

(73) Assignee: Akzo Nobel Chemicals International B.V., Amersfoort (NL)

(21) Appl. No.: 13/146,573

(22) PCT Filed: Jan. 29, 2010
(86) PCT No.: PCT/EP2010/051110

§ 371 Date: Jul. 27, 2011

Related U.S. Application Data
(60) Provisional application No. 61/149,235, filed on Feb. 2, 2009.
(60) Provisional application No. 61/165,831, filed on Apr. 1, 2009.

(30) Foreign Application Priority Data
Sep. 22, 2009 (EP) 09170941.0

(51) Int. Cl. B41M 5/52; C09D 129/04

(52) U.S. Cl. 428/32.1; 524/557; 524/436; 524/158; 524/47

(57) ABSTRACT

A method for making printing paper comprising preparing an ink receiving surface coating composition which comprises an optical brightening agent (OBA), polyvinyl alcohol (PVOH) and a water soluble divalent salt, wherein the PVOH and OBA are added to the coating prior to the salt, and applying said coating composition onto at least one surface of said paper; and a surface coating composition which comprises a protected OBA and a water soluble divalent salt.

This application claims priority based on U.S. Provisional Application No. 61/149,235, filed Feb. 2, 2009; U.S. Provisional Application No. 61/165,831, filed Apr. 1, 2009; and European Patent Application No. 9170941.0, filed Sep. 22, 2009, the contents of which are incorporated herein by reference in their entirety.

### FIELD OF THE INVENTION

The field of the invention relates to paper making processes for improving brightness and whiteness of the paper. More particularly, it refers to a papermaking process to increase the CIE whiteness of the paper while maintaining TAPPI brightness when a water soluble divalent salt, e.g., calcium chloride, is added to the surface of the paper.

### BACKGROUND OF THE INVENTION

ColorLok® Technology, developed jointly by Hewlett Packard and International Paper, has been described as providing printing paper with better print quality, faster drying time and consistent, reliable printing. More specifically, it has been represented that this technology prevents wicking in inkjet papers; black color looks up to 40% bolder than the Everyday HP paper grade; images are richer and brighter and the graphics are 10% more vivid; and ink drying is three times faster than ordinary paper. There has been interest by other paper manufactures to provide printing paper according to the performance standards of ColorLok papers. The ColorLok Technology is based on a surface coating containing calcium chloride and preferably a cationic polymer. The coating also generally includes starch and sizing agents. The ColorLok Technology is the subject of patent applications, including U.S. Published Application 2007/0087138 A1 (which is incorporated herein by reference), and is being offered as a license to mills. Mills can either use the ColorLok Technology or use their own technologies and chemistries to conform to the ColorLok standards and earn the right to display the ColorLok logo on their products. However, a problem has been identified with mills trying to achieve the ColorLok standards, in complying with the high brightness and whiteness requirements.

At least one attempt to reach the whiteness target has been to increase the optical brightening agent (OBA) usage by 20 to 40%. This constitutes a problem for mills because of the short supply of OBAs, the adverse charge effect that OBA has at the wet end, and the environmental issues associated with OBA. The global demand was created when the capacity for diamino stilbenic acid (DAS), a key raw material of fluorescent whitening agents (FWAs) or OBAs, was reduced. DAS was already in short supply and reduction in capacity has forced a global cost increase for this raw material. Additionally, production of para-nitrotoluene an important pre-cursor for DAS has been restricted in some countries. The OBA supply shortage has not only contributed to price increases, but has caused unmet deliveries and loss of supply.

In an effort by mills to increase their CIE whiteness, they have also increased the calcium chloride and sizing agent dosages. However, this solution fails to reach the high target whiteness requirements. The difficulty is that even if mills are able to reach target brightness, they are unable to reach the whiteness because the chemicals that contribute to increasing brightness adversely effects whiteness. Further, mills do not want to increase the consumption of OBA due to the cost and this is impeding the mill from reaching CIE whiteness targets.

Despite considerable efforts to increase whiteness while maintaining TAPPI brightness at the same OBA level, there exists a need to increase paper whiteness when calcium chloride, starch, and sizing agents are components of a size press additive used to enhance inkjet printing.

### SUMMARY OF THE INVENTION

It has been found that calcium chloride, the main chemical used in the ColorLok technology, can interfere with size press chemistry and can contribute to paper whiteness reduction when mixed with starch, sizing, and OBAs.

Test results show that some of the components used at the size press for the ColorLok technology are detrimental to whiteness. The inventors have found that starch, one such factor, should be restricted to a certain dosage to prevent significant whiteness loss. It has been found that OBAs coupled with high starch addition also contributes to whiteness loss when these are added to the surface of the paper. Certain sizing agents can also contribute to whiteness loss. However, these chemicals are essential to paper making. Starch imparts strength, sizing makes the paper water resistant, and OBA is used to add whiteness and brightness to the paper. Therefore, it would be beneficial to optimize whiteness without losing brightness, strength, or water resistance, and to reduce OBA/FWA dosage while preserving the main properties required for inkjet paper.

It has been found that polyvinyl alcohol (PVOH), in solution or in powder form, can be substituted for the starch and that making this substitution produces paper having sufficient strength even with a reduction of starch and having increased brightness and CIE whiteness. Results also show that adding Premier Blue, a phthalocyamine blue pigment Dye, along with the PVOH helps improve the whiteness of the paper. These components when used with the ColorLok components in sufficient amount and, in one embodiment, in an appropriate addition sequence, result in significantly increased whiteness of the paper. Additionally, the inventors have found that when silica is appropriately added to the surface formulation, TAPPI brightness also increases.

In a first aspect, the invention is directed to an ink recording sheet (or printing paper) containing a water soluble divalent salt on at least one surface of the sheet and further comprising PVOH in contact with the salt in an amount sufficient to increase whiteness of the sheet at least 10 CIE whiteness points compared to a sheet with no PVOH on the sheet surface. In one embodiment, the PVOH is in an amount sufficient to increase whiteness of the sheet at least 20 CIE whiteness points, or at least 30 points, or at least 40 points. In one embodiment, the final CIE whiteness is at least about 150 or at least about 160 or at least about 170.

In another aspect, the invention is directed to a surface coating based on the ColorLok Technology having improved whiteness compared to typical ColorLok surface coatings. The surface coating includes a protected OBA and a water soluble divalent salt.

In another aspect, the invention is directed to a method for increasing whiteness of printing paper that is made using the ColorLok Technology components in the surface coating, i.e., a water soluble divalent salt, e.g., calcium chloride, and one or more starches, the method comprising replacing at least some of the starch with PVOH in an amount sufficient to increase the CIE whiteness. In an embodiment, the weight ratio of PVOH to starch in the surface coating, e.g., the size press coating composition, is at least 1:3, or at least 1:2 or at least 1:1. In one embodiment, that amount of starch is less than about 55 lbs/ton (27.5 kg/metric ton (MT)) (dry basis of paper suspension), or less than 45 lbs/ton (22.5 kg/MT), or less than 40 lbs/ton (20 kg/MT), or less than 30 lbs/ton (15 kg/MT), or less. In one embodiment, there is no starch added to the coating composition.

In one embodiment, that surface coating is prepared by sequentially adding components, wherein the PVOH (or the PVOH and starch) and an OBA are added to the coating prior to the salt being added. In one embodiment, the PVOH (or the PVOH and starch) is added between an OBA and the salt, e.g., calcium chloride. In one embodiment, an OBA is added first and the PVOH (or PVOH and starch) is added prior to adding the salt. In one embodiment, the PVOH is added in an amount sufficient so that the OBA can be reduced by at least about 10%, without a significant reduction in brightness. In another embodiment, the OBA is reduced by at least about 20%, or at least about 25%, or at least about 30%, without a significant reduction in brightness.

In another embodiment, a dye component is also added to the surface coating. The PVOH can be premixed with the dye component and added prior to the salt. In one embodiment, the surface coating composition also comprises silica. In one embodiment, the silica is non-porous silica.

In another embodiment, PVOH is premixed with OBA. In one embodiment, the following are added to the premix in the order listed: Dye, Starch, Sizing and Calcium Chloride.

In another embodiment, PVOH is premixed with Dye. In one embodiment, the following are added to the premix in the order listed: OBA, Starch, Sizing and Calcium Chloride.

In one embodiment, the starch is treated with an enzyme. The starch can be added to a surface coating formulation in an amount from about 40 60 lb/ton starch, based on the dry weight of the paper stock. The other components can be added in the following amounts: from about 5 to about 10 lb/ton PVOH, from about 0.02 to about 0.03 Dye, about 10 to about 30 lb/ton calcium chloride, about 0.7 to about 1.5 lb/ton Sizing, and about 4 to about 10 lb/ton OBA, based on dry weight of paper stock.

The specific types of components, e.g., OBA, PVOH, dye, and silica, used in the coating composition, and specific sequences of components, can include any of the components and sequences described more fully below.

Additional objects, advantages and novel features will be apparent to those skilled in the art upon examination of the description that follows.

### BRIEF DESCRIPTION OF THE DRAWINGS

FIG. 1 is a graph showing the effect of refining on brightness and whiteness.

FIG. 2 is a graph showing initial brightness and whiteness of different hand sheets.

FIG. 3 is a graph showing effect of OBA dosage on whiteness.

FIG. 4 is a graph showing whiteness for hand sheets having different wet end chemicals.

FIG. 5 is a graph showing whiteness for hand sheets having different coatings.

FIG. 6 is a graph showing whiteness for selected hand sheets with three different coatings.

FIG. 7 is a graph showing whiteness for selected hand sheets with silica based coatings.

FIG. 8 is a graph showing whiteness as a function of starch and PVOH levels in coatings.

### DETAILED DESCRIPTION OF THE INVENTION

OBAs are used to increase the brightness and/or whiteness of paper. OBAs can be added separately to the wet end or surface coating, e.g., the size press, or to both. Addition to the wet end means that the OBA is added to the fibers with other wet end chemicals before the paper is made. Once the paper is made it often goes through the size press where additional chemical additives are applied on the surface of the paper.

In one aspect the invention is directed to a surface coating based on the ColorLok technology that provides increased whiteness compared to a typical or standard ColorLok formulation. The surface coating having increased whiteness contains a protected OBA component, along with the water soluble divalent salt.

The term protected OBA means that the OBA is protected by a PVOH component. The PVOH component can be PVOH, a PVOH solution, or PVOH in combination with one or more other components. The OBA can be protected by contacting the OBA with PVOH (or, e.g., a combination of dye and PVOH) prior to the OBA contacting the salt, wherein the PVOH is present in an amount sufficient to increase CIE whiteness compared to a coating with no PVOH. In one embodiment, the OBA is protected by silica and the PVOH. The protection can be achieved in accordance with the methods for preparing the surface coating, as described more fully herein.

A surface coating according to the invention can be prepared by sequentially adding components, wherein the PVOH (or PVOH and starch) and an OBA are added to the coating prior to the salt being added. In one embodiment, the PVOH (or PVOH and starch) is added between the addition of the OBA and the salt, e.g., calcium chloride. In one embodiment, the OBA is added first and the PVOH (or PVOH and starch) is added prior to adding the salt. In one embodiment, the PVOH is added in an amount sufficient so that the OBA can be reduced by at least about 10% compared to the typical ColorLok formulation, without a significant reduction in brightness. In another embodiment, the OBA is reduced by at least about 20%, or at least about 25%, or at least about 30%, without a significant reduction in brightness.

A dye component can also be added to the surface coating. The PVOH can be premixed with the dye component and added prior to the salt. In one embodiment, the surface coating composition also comprises silica. In one embodiment, the silica is non-porous silica. The silica can be dispersed, i.e., be substantially non-aggregated. In one embodiment the silica has an average particle size or at least about 30 nm or at least about 40 nm. In one embodiment the silica has a specific surface area less than about 100 m²/g or less than about 80 m²/g.

In another embodiment, PVOH is premixed with OBA. In one embodiment, the following are added to the premix in the order listed: Dye, Starch, Sizing and Calcium Chloride.

In another embodiment, PVOH is premixed with Dye. In one embodiment, the following are added to the premix in the order listed: OBA, Starch, Sizing and Calcium Chloride.

In one embodiment, the surface coating chemicals are added in the following order: PVOH and Pigment (dye) premix, OBA, Starch, Sizing and Calcium Chloride. In one embodiment, the types of chemicals and amounts used can be as follows: about 4-5 lb/t Hexa OBA, about 8 lb/t PVOH, about 40-50 lb/t starch (treated with enzme), about 1.0 to 1.25 lb/t SPAE76 (sizing), about 0.02 lb/t XP3057 (blue pigment), and about 20 lb/t Calcium Chloride, based on the dry weight of the paper.

### EXAMPLES

Chemical addition to the wet end was simulated in the lab by making handsheets and adding chemicals, one at the time, and in certain sequences to the bleached and refined pulp. The handsheets were pressed and dried prior to adding surface treatment. The size press chemical addition was simulated by applying the coating formulation with a rod to the surface of the handsheets. The chemicals on the surface were applied with an automated draw down table. After the surface additives were applied, the handsheets were dried with a lab scale infra-red dryer.

### Equipment and Test Methods

This section lists the instruments, equipment, and test methods used to make the handsheets and to measure the desired properties. The equipment used includes: 1) handsheet molds to make the handsheets, 2) wet press, 3) drum dyers to dry the handsheets 4) automated draw down table to coat the handsheets, 5) lab scale IR dryer, 6) Technidyne Color Touch brightness meter to test for D65 brightness, CIE whiteness, scattering and absorption coefficients, and 7) Technidyne Brightmeter to test for TAPPI brightness.

Brightness D65 Test Method was performed with the Technidyne according to ISO 2470:1999. Calibration of UV content is described in ISO 11475:2002 and whiteness CIE/10° according to ISO 1475:2002. The test methods used to measure freeness of the refined and unrefined pulp was the Canadian Standard of Freeness Test (TAPPI method T227).

### Example 1

To address loss of whiteness at a mill using the ColorLok Technology, preliminary experiments were done to determine the root cause of the whiteness loss.

Pulp pads were used to measure the initial brightness and whiteness of the pulp. Handsheets were used to study the effect chemicals have on whiteness and brightness when the chemicals are added to the wet end or size press. For this set of experiments, pulp pads and handsheets were made using unrefined and refined hardwood (HW) and softwood (SW) pulp from a Southern U.S. mill. Part of the pulp received was refined and the rest of the pulp was left unrefined. Both handsheets and pulp pads were made with refined and unrefined HW and SW fibers. Pads were also made with a mixture of 70% HW and 30% SW fibers. Pulp pads and handsheets were tested for brightness and whiteness. To obtain the initial brightness and whiteness measurements, blank pulp pads and handsheets were made, that is no chemicals were added to either the pulp or the surface of the paper.

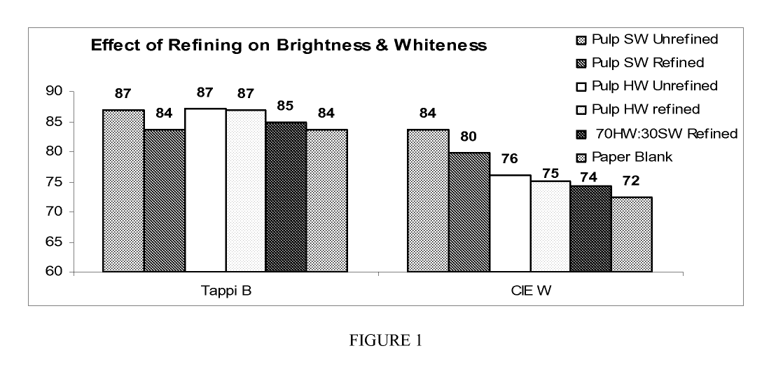

FIG. 1 shows the effect refining has on brightness and whiteness of pulp and paper. From the pulp test results, we observed that hardwoods have lower initial whiteness than softwoods (unrefined SW: 84 vs. unrefined HW: 76). However, unrefined SW and HW have the same initial brightness. The ratio of HW to SW is 70:30, which means that paper made with 70% HW and 30% SW ratio will go through more loss of whiteness than of TAPPI brightness.

### Example 2

A Southern U.S. mills base paper was simulated by adding chemicals to the fibers in the sequence typical to the mill. Handsheets were also made with the same fibers, but with different wet end chemicals and sequences. 81 different sets of handsheets were made using the same pulp, but with different wet end chemicals and sequences to compare the whiteness performance and determine the factors that contribute to handsheet whiteness.

With the starting handsheet brightness of 84 and whiteness of 72, 81 sets of handsheets were made with different chemicals added to the fibers. From the 81 handsheets, 7 with highest whiteness (A G) were selected in addition to the mills handsheet and a set of blank handsheets made without chemicals.

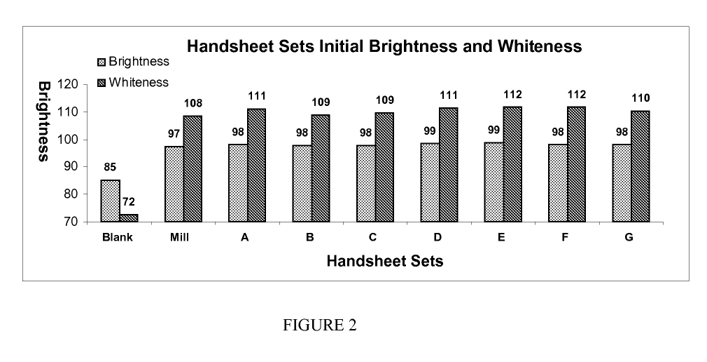

FIG. 2 shows brightness (B) and whiteness (W) for different handsheet sets: 1) blank, 2) the control mill set, and 3) handsheet sets A-G. The results show that mill handsheet set has higher B and W than the blank handsheet set, but lower B and W than the other handsheet sets. For this set of experiments 10 lb/ton of tetra OBA was used for all handsheets. The mill handsheet sets were made with 3V OBA, but the other handsheets were made with Clariant OBA.

### Example 3

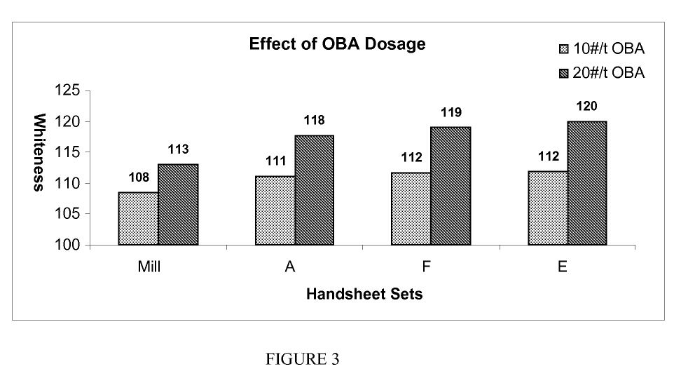

From the 10 different sets of handsheets (A G), three sets (A, F, and E) in addition to the mills set were selected to test the effect of the OBA dosage. In this set of experiments handsheets with different wet end chemicals and sequences were made using two different dosages of OBA 10 lb/ton and 20 lb/ton as shown in FIG. 3. Handsheets made with 20 lb/ton OBA tetra at the wet end obtained higher whiteness than those made with 10 lb/ton OBA at the wet end. Mill handsheets had lower whiteness than the other handsheet set at both OBA dosages.

As shown in FIG. 3, this set of experiments shows that with higher OBA dosages it is possible to increase the whiteness of all handsheets. However, when comparing handsheet sets mill to F and E, it is clear that the mill could benefit by changing the chemicals in the base sheet to increase the whiteness of their paper.

Table 1 shows the formulations for handsheet sets F and G. This illustrates that the chemicals and their sequences added to the same pulp at the same OBA dose can create paper with different whiteness.

TABLE 1
Chemicals and their Sequences for Handsheet Sets F and G

| | |
|---|---|
| Handsheet F | Handsheet G |

| | Dosage | | Dosage |
|---|---|---|---|
| Additive | lb/ton | Additive | lb/ton |
| L-OBA | 10 | PCC | 400 |
| PCC | 400 | L-OBA | 10 |
| Dye | 0.1 | Alum | 2 |
| ASA/Stalok 400 | 1.3/5.2 | Dye | 0.1 |
| PAC | 1 | Starch | 10 |
| PL 2510 | 1 | PL 1610 | 0.3 |
| Eka NP 442 | 1 | NP 320 | 1.25 |
| | | BMA-0 | 1.25 |

### Example 4

The prior examples show that the chemicals added to the wet end can only reach a certain level of whiteness and brightness. Additional whiteness and brightness can be obtained by adding surface chemicals. For this set of experiments, the base sheet had neither internal nor surface size. The TAPPI brightness of the base sheet was 92 and CIE whiteness was 138. Table 2 shows a list of the chemicals used, the chemicals percentage solids and the chemical manufacturers. The equipment used for surface addition is an automatic drawn down table and a lab scale IR dryer.

To increase the whiteness and brightness of the base sheet, 68 different surface coatings were prepared including the mill coating. Handsheets from sets A G and mill were coated with the mills surface formulation and a few other formulations to determine the paper-coating interaction and the effect these have on brightness and whiteness of paper.

TABLE 2
List of Chemicals, Percentage Solids and Source of Origin

| Size Press Chemicals | Solids | Source |
|---|---|---|
| Enzyme Converted Pearl Starch | 12% | National Starch |
| Hexa OBA | 30.8% | 3 V |
| Tetra OBA | 22.6% | 3 V |
| Salt | 18.2% | Mill |
| Eka SP AE 76 (Anionic SAE size) | 39.3% | Eka |
| Calcium Chloride | 38% | Mill |
| PVOH 24-203 | 14% | Celvol |
| Leucophor CE Tetra OBA | 53.6% | Clariant |
| Eka SP 50 (amphoteric SAE size) | 59% | Eka |
| Silica Bindzil 50/80 | 50% | Eka |
| Premier Blue Pigment (diluted to 2% | 38.0% | Royal Pigments |
| solids) □Dye□ | | |

Nearly 70 different formulations were developed using the chemicals in Table 2. The goal was to determine the most suitable and most cost effective formulation(s) to increase the whiteness of the paper while maintaining/increasing the papers brightness.

Table 3 shows a version of the ColorLok technology.

TABLE 3
ColorLok Formulation, Percentage Solids, and Dosages

| | Solids | Dose (Lb/ton) |
|---|---|---|
| Chemicals | (%) | Dry Basis |
| Starch | 12 | 90 □ 110 |
| Hexa OBA | 30.8 | 15-23 |
| Calcium Chloride | 38 | 15 □ 20 |
| Eka SP AE 76 | 39.3 | 0.7 □ 0.9 |

Table 4 shows a list of formulations using the chemicals in Table 3 and a few other chemicals. These formulations were used to determine the effect each chemical had on whiteness and brightness, and compatibility between the chemicals in the formulation. With this information, the best chemical sequence to increase whiteness while preserving brightness was determined.

TABLE 4
OBA Interaction with other surface chemicals

| | | | | | | | | | TAPPI | D65 | CIE |
|---|---|---|---|---|---|---|---|---|---|---|---|
| Condition | | | | Calcium | Size | OBA | Leucophor | Coat | Brightness | Brightness | Whiteness |
| # | Chemicals | Starch | PVOH | Chloride | SPAE76 | Hexa | Ce Tetra | Weight | (TB) | (B) | (W) |
| | Base Sheet | | | | | | | NA | 92 | 102 | 138 |
| | Chemical Compatibility | | | | | | | Results | | | |
| 1 | Starch | | | | | | | 4 | 91 | 103 | 141 |
| | Enzyme Pearl | | | | | | | | | | |
| 2 | SP AE 76 | | | | 0.7 | | | 9 | 76 | 83 | 90 |
| 3 | Salt | | | | | | | 12 | 92 | 104 | 143 |
| 4 | Hexa + Starch | 70 | | | | 13 | | 4 | 93 | 110 | 155 |
| 5 | OBA Hexa + | | | | 0.7 | 13 | | 9 | 83 | 94 | 86 |
| | SPAE76 | | | | | | | | | | |
| 6 | Hexa + Salt | | | | | 13 | | 8 | 85 | 97 | 94 |
| 7 | Hexa + PVOH | | 49 | | | 13 | | 3 | 96 | 113 | 166 |
| | 24-203 @12% | | | | | | | | | | |
| 8 | OBA Hexa + | | | 15 | | 13 | | NA | NA | NA | NA |
| | Calcium | | | | | | | | | | |
| | Chloride | | | | | | | | | | |
| 9 | Calcium | | | 15 | | | | 14 | 92 | 103 | 139 |
| | Chloride | | | | | | | | | | |
| 10 | Leucophor CE | | 57 | | | | 6 | 3 | 95 | 112 | 164 |
| | (tetra) + PVOH | | | | | | | | | | |
| 13 | PVOH 24-203 | | 64 | | | | | 3 | 92 | 103 | 143 |
| | @12% | | | | | | | | | | |
| 15 | Leucophor CE | 66 | | | | | 6 | 3 | 94 | 109 | 152 |
| | (tetra) + Starch | | | | | | | | | | |

The following observations were made for the coatings listed in Table 4: the base sheet was used as a control; conditions 1, 3 and 9 had no adverse effect on B or W; conditions 2, 5 and 6 decreased (and in some cases significantly decreased) TB, D65B and W; conditions 4, 7, and 15 increased B and W; condition 8 precipitated out, showing incompatibility between OBA Hexa and calcium chloride; and condition 13 maintained B and increased W.

Condition 8 (Table 4) shows that calcium chloride, the chemical necessary for the ColorLok technology, was not compatible with hexasulphonated OBA (Hexa). This incompatibility caused the solution to precipitate out. Similarly, condition 5 shows that when the surface size (SAE anionic) is added to OBA Hexa directly there was a significant decrease in whiteness and brightness. Comparing the whiteness between conditions 4 and 5, condition 5 (OBA Hexa and SPAE76) shows a 69 point drop in whiteness compared to condition 4 (OBA Hexa and starch). Condition 6 shows that salt also contributed to whiteness decrease when added to the OBA directly. These decreases in whiteness show the importance of chemical sequences in the coating formulations.

There are however, certain chemical sequences that were found to increase whiteness of paper. For example, the best combination in Table 4 was OBA and PVOH as shown in conditions 7 and 10. Two different types of OBAs were used. The PVOH-Hexa OBA combination had slightly higher whiteness (166) than the PVOH-Leucophor CE combination (164). Leucophor CE is a tetra OBA and the dosage used for the tetra was less than half that of the Hexa OBA. These experiments show that PVOH has good compatibility with OBA and increases brightness and whiteness significantly compared to the combination of OBA and starch (condition 4 compared to 7, and condition 10 compared to 15). PVOH mixed with either OBA Hexa or Leucophor CE (tetra) had 10 point higher whiteness than when using the Pearl enzyme modified starch with either OBA.

### Example 5

The base sheet was coated with different surface formulations. The coated sheets ranged from 4 to 8 g/m² (100 to 200 lb/ton) depending on whether or not the coating formulation contained silica. The formulations that contained silica ranged from 6 to 8 g/m² and those without silica ranged between 4 to 6 g/m².

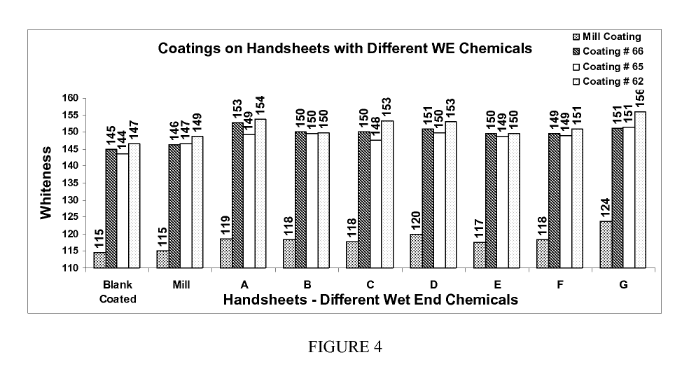

FIG. 4 shows the interaction between paper and coatings. Nine handsheet sets and four different coatings were used to determine the effect wet end and size press chemicals have on whiteness. A review of FIG. 4 reveals that: 1) The same whiteness (115) was obtained when the blank and the mill handsheet were coated with the ColorLok coating; 2) By coating handsheet set G with ColorLok coating increased whiteness by 9 points from 115 (mill handsheet with ColorLok coating) to 124 (G handsheet with ColorLok coating); 3) When mill handsheet was coated with coating #62 (coating shown in Table 5 below) the whiteness increased to 149 (34 points higher than when mill handsheet was coated with ColorLok coating); and 4) When handsheet G was coated with coating #62 the whiteness was 156 (32 points higher than when G was coated with ColorLok coating).

Thus, FIG. 4 shows that whiteness can be increased significantly if the base sheets wet end chemicals and the coating formulation have good interaction. It is important to also have good understanding of the combined dosage effect because too much OBA can reach the greening level and decrease the brightness and whiteness of the paper.

These experiments show that the whiteness obtained by the mill using their current chemicals at the wet end and size press can be used in a certain way, e.g., amounts and sequences, to achieve high whiteness and brightness.

### Example 6

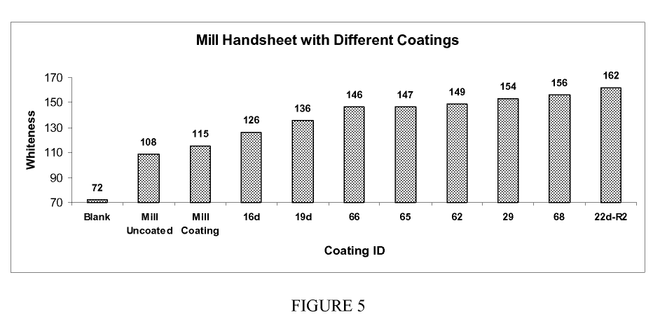

Mill handsheets were coated with several different coating formulations including the ColorLok surface coating. The results are shown in FIG. 5, with the blank handsheet set serving as the control. No chemicals were used to make the blank handsheets and there was no coating formulation added to the surface of the blank handsheets. The CIE whiteness of the blank handsheet was 72. The uncoated mill handsheet (made with wet end chemicals) had a whiteness of 108. After coating the mill handsheet with the ColorLok coating, there was a whiteness increase of 7 points (uncoated mill handsheet whiteness 108 compared to coated whiteness 115). The rest of the mill handsheets coated with coatings 16d, 19d, 66, 65, 62, 29, 68, 22d-R2 (coatings described in Table 5) ranged in whiteness from 126 to 162 depending on the coating formulation used. That is, adding different coating formulations to the same base sheet increased whiteness an amount from 11 to 47 points.

This set of experiments demonstrates that applying different coating formulations to the same base sheet can significantly increase paper whiteness by up to 47 points.

### Example 7

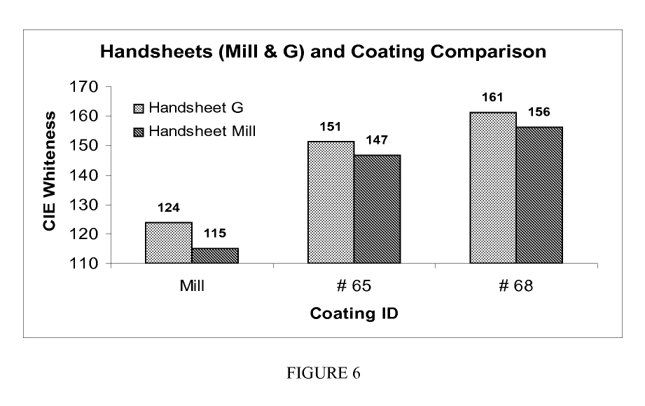

To better demonstrate the base sheet-coating interaction, two handsheet sets: mill (simulation of the mills paper) and G (made with chemicals in Table 1) were selected. These handsheets were coated with three different coating formulations: ColorLok, 65, and 68 as shown in FIG. 6. As shown in FIG. 6, the results show that coated handsheet G performed better than coated mill handsheet. Comparing the whiteness performance of the two base sheets (mill and G handsheets) both coated with ColorLok coating formulation, it can be seen that the G handsheet was 9 points higher in whiteness. FIG. 6 further shows that coating formulation #68 coated on either of the sheets performs better than the other two coating formulations (#65 and ColorLok). Mill handsheet with coating #68 had 41 points higher whiteness than when coated with ColorLok coating. The highest whiteness was obtained with G handsheet and coating #68. That combination was 46 points higher whiteness than the mill handsheet/ColorLok coating combination.

A review of the examples above reveals that the base sheet, coating, and the interaction of these has significant effect on the final whiteness of the paper.

Table 5 shows a list containing over 68 surface coating formulations. The chemicals are given in dry pounds per ton. The table shows D65 and TAPPI brightness and CIE whiteness.

Some of these formulations have been evaluated in subgroups and are listed in Tables 6 10. The subgroups show the effect certain chemicals have on whiteness and brightness.

TABLE 5
Formulations (dry lb/ton) and Results

| | | | | | | | | | | | CIE | | |
|---|---|---|---|---|---|---|---|---|---|---|---|---|---|
| Condition # | | | | | | | Calcium | SP AE | | | Whiteness | | |
| Target | Starch | | | Hexa | | Leucophor | Chloride | 76 | SP AE | | Target | TAPPI | D65 |
| #/ton | 90-110 | PVOH | Silica | 15-23 | Tetra | CE | 15 | 0.7 | 50 | Dye | 157 | Brightness | Brightness |
| 1 | 87.0 | 0.0 | 0.0 | 0.0 | 0.0 | 0.0 | 0.0 | 0.0 | 0.0 | 0.000 | 141.31 | 91.3 | 103.1 |
| 4 | 69.5 | 0.0 | 0.0 | 12.5 | 0.0 | 0.0 | 0.0 | 0.0 | 0.0 | 0.000 | 154.68 | 93.4 | 110.39 |
| 7 | 0.0 | 49.2 | 0.0 | 8.8 | 0.0 | 0.0 | 0.0 | 0.0 | 0.0 | 0.000 | 165.79 | 95.7 | 113.24 |
| 10 | 0.0 | 57.1 | 0.0 | 0.0 | 0.0 | 6.9 | 0.0 | 0.0 | 0.0 | 0.000 | 163.65 | 95.1 | 112.12 |
| 11 | 0.0 | 28.6 | 63.5 | 0.0 | 0.0 | 3.5 | 0.0 | 0.0 | 0.0 | 0.015 | 164.07 | 95.5 | 111.77 |
| 12 | 0.0 | 31.5 | 69.8 | 0.0 | 0.0 | 3.8 | 10.5 | 0.0 | 0.0 | 0.017 | 164.56 | 95.2 | 112.18 |
| 12a | 35.7 | 0.0 | 79.2 | 0.0 | 0.0 | 4.3 | 11.9 | 0.0 | 0.0 | 0.019 | 149.12 | 93.4 | 106.28 |
| 12as | 33.5 | 0.0 | 74.3 | 0.0 | 0.0 | 4.1 | 11.1 | 0.9 | 0.0 | 0.018 | 149.15 | 93 | 106.24 |
| 12s | 0.0 | 37.5 | 83.1 | 0.0 | 0.0 | 4.5 | 12.4 | 0.4 | 0.0 | 0.020 | 170.12 | 95.6 | 112.03 |
| 12s-R | 0.0 | 22.6 | 100.3 | 0.0 | 0.0 | 5.5 | 15.0 | 0.5 | 0.0 | 0.024 | 160.47 | 94.5 | 108.25 |
| 13 | 0.0 | 64.4 | 0.0 | 0.0 | 0.0 | 0.0 | 0.0 | 0.0 | 0.0 | 0.000 | 142.69 | 92.2 | 103.35 |
| 15 | 65.8 | 0.0 | 0.0 | 0.0 | 0.0 | 5.3 | 0.0 | 0.0 | 0.0 | 0.000 | 151.99 | 93.6 | 109.11 |
| 16-2 | 92.0 | 0.0 | 0.0 | 16.5 | 0.0 | 0.0 | 20.4 | 0.0 | 0.0 | 0.000 | 142.35 | 92.5 | 108.35 |
| 16 | 78.8 | 0.0 | 0.0 | 14.2 | 0.0 | 0.0 | 17.4 | 0.6 | 0.0 | 0.000 | 138.71 | 92.2 | 109.53 |
| 16d | 73.8 | 0.0 | 0.0 | 13.3 | 0.0 | 0.0 | 16.3 | 0.6 | 0.0 | 0.029 | 146.29 | 92.6 | 107.86 |
| 19 | 64.1 | 0.0 | 0.0 | 0.0 | 0.0 | 5.2 | 14.2 | 0.6 | 0.0 | 0.000 | 145.85 | 92.5 | 108.08 |
| 19d | 76.3 | 0.0 | 0.0 | 0.0 | 0.0 | 6.2 | 16.9 | 0.6 | 0.0 | 0.030 | 151.78 | 92.2 | 107.67 |
| 22 | 0.0 | 59.4 | 0.0 | 16.0 | 0.0 | 0.0 | 19.7 | 0.8 | 0.0 | 0.000 | 166.047 | 94.9 | 114.32 |
| 22d | 0.0 | 41.5 | 0.0 | 11.2 | 0.0 | 0.0 | 13.8 | 0.5 | 0.0 | 0.022 | 171.42 | 94.6 | 113.06 |
| 22d-R | 0.0 | 28.7 | 0.0 | 15.5 | 0.0 | 0.0 | 19.1 | 0.7 | 0.0 | 0.030 | 167.32 | 93.9 | 111.54 |
| 22d-R2 | 0.0 | 55.4 | 0.0 | 7.5 | 0.0 | 0.0 | 18.4 | 0.7 | 0.0 | 0.029 | 175.71 | 93.5 | 109.69 |
| 22d-R2 | 0.0 | 48.8 | 0.0 | 3.3 | 0.0 | 0.0 | 16.2 | 0.6 | 0.0 | 0.004 | 168.39 | 94.5 | 112.35 |
| 23 | 0.0 | 73.6 | 0.0 | 0.0 | 0.0 | 8.9 | 24.5 | 0.0 | 0.0 | 0.000 | 164.53 | 94.2 | 113.1 |
| 24 | 0.0 | 68.2 | 0.0 | 0.0 | 0.0 | 8.3 | 22.7 | 0.8 | 0.0 | 0.000 | 163.8 | 94.5 | 112.73 |
| 25 | 0.0 | 65.4 | 0.0 | 0.0 | 0.0 | 7.9 | 21.7 | 0.9 | 0.0 | 0.006 | 165.72 | 94.2 | 112.35 |
| 26 | 0.0 | 41.4 | 0.0 | 0.0 | 0.0 | 10.0 | 27.5 | 1.1 | 0.0 | 0.007 | 160.49 | 94.1 | 110.78 |
| 27 | 0.0 | 43.1 | 0.0 | 11.6 | 0.0 | 0.0 | 14.3 | 0.0 | 0.0 | 0.000 | 165.69 | 94.8 | 114.47 |
| 28 | 0.0 | 29.1 | 0.0 | 7.9 | 0.0 | 0.0 | 9.7 | 0.3 | 0.0 | 0.000 | 164.95 | 94.2 | 114.1 |
| 29 | 0.0 | 49.6 | 0.0 | 13.4 | 0.0 | 0.0 | 16.5 | 0.6 | 0.0 | 0.013 | 166.7 | 95.7 | 113.95 |
| 30 | 0.0 | 40.8 | 0.0 | 22.0 | 0.0 | 0.0 | 27.1 | 1.0 | 0.0 | 0.022 | 164.74 | 95.7 | 113.76 |
| 31 | 60.3 | 0.0 | 0.0 | 0.0 | 7.9 | 0.0 | 13.3 | 0.5 | 0.0 | 0.000 | 118.76 | 90.9 | 103.21 |
| 32 | 57.3 | 0.0 | 0.0 | 0.0 | 7.5 | 0.0 | 12.7 | 0.4 | 0.0 | 0.010 | 122.81 | 90 | 103.82 |
| 33 | 0.0 | 35.7 | 79.1 | 0.0 | 0.0 | 4.3 | 11.9 | 0.0 | 0.0 | 0.009 | 164.16 | 96.8 | 113.74 |
| 34 | 0.0 | 36.1 | 80.1 | 0.0 | 0.0 | 4.4 | 12.0 | 0.4 | 0.0 | 0.010 | 164.92 | 96.9 | 113.99 |
| 35 | 0.0 | 26.9 | 119.1 | 0.0 | 0.0 | 6.5 | 17.8 | 0.6 | 0.0 | 0.014 | 162.66 | 96.8 | 113.68 |
| 36 | 51.0 | 0.0 | 75.5 | 9.2 | 0.0 | 0.0 | 11.3 | 0.0 | 0.0 | 0.009 | 144.73 | 94.2 | 108.35 |
| 37 | 49.9 | 0.0 | 73.7 | 9.0 | 0.0 | 0.0 | 11.0 | 0.4 | 0.0 | 0.009 | 145.28 | 94.2 | 108.6 |
| 38 | 50.9 | 0.0 | 75.2 | 0.0 | 6.7 | 0.0 | 11.3 | 0.0 | 0.0 | 0.009 | 126.08 | 91.9 | 104.71 |
| 39 | 38.3 | 0.0 | 56.7 | 0.0 | 5.0 | 0.0 | 8.5 | 0.3 | 0.0 | 0.007 | 124.52 | 91.7 | 103.65 |
| 40 | 0.0 | 45.1 | 0.0 | 0.0 | 8.9 | 0.0 | 15.0 | 0.0 | 0.0 | 0.000 | 165.66 | 95.3 | 114.05 |
| 41 | 0.0 | 46.1 | 0.0 | 0.0 | 9.1 | 0.0 | 15.3 | 0.5 | 0.0 | 0.000 | 165.47 | 95 | 114.02 |
| 42 | 69.9 | 0.0 | 0.0 | 12.6 | 0.0 | 0.0 | 15.5 | 0.0 | 0.0 | 0.000 | 143.34 | 93.4 | 109.06 |
| 43 | 44.4 | 0.0 | 0.0 | 8.0 | 0.0 | 0.0 | 9.8 | 0.0 | 0.65 | 0.000 | 140.56 | 92.7 | 108.04 |
| 44 | 33.9 | 0.0 | 0.0 | 6.1 | 0.0 | 0.0 | 7.5 | 0.0 | 0.50 | 0.006 | 145.21 | 92.9 | 108.99 |
| 45 | 39.4 | 0.0 | 0.0 | 5.9 | 0.0 | 0.0 | 7.3 | 0.0 | 0.46 | 0.006 | 148.04 | 93.7 | 109.35 |
| 46 | 43.2 | 14.4 | 0.0 | 15.5 | 0.0 | 0.0 | 19.1 | 0.7 | 0.0 | 0.015 | 159.31 | 94.8 | 112.22 |
| 47 | 0.0 | 41.5 | 0.0 | 0.0 | 8.2 | 0.0 | 13.8 | 0.5 | 0.0 | 0.011 | 161.25 | 94.9 | 113.25 |
| 48 | 50.3 | 0.0 | 0.0 | 13.6 | 0.0 | 0.0 | 11.1 | 0.0 | 0.72 | 0.009 | 103.35 | 86.3 | 96.95 |
| 49 | 61.8 | 0.0 | 0.0 | 0.0 | 0.0 | 16.7 | 11.4 | 0.0 | 0.69 | 0.009 | 143.36 | 94 | 107.85 |
| 49R | 56.5 | 0.0 | 0.0 | 0.0 | 0.0 | 3.8 | 10.4 | 0.0 | 0.67 | 0.008 | 144.64 | 92.1 | 106.58 |
| 50 | 55.0 | 18.3 | 0.0 | 0.0 | 14.5 | 0.0 | 24.4 | 0.9 | 0.0 | 0.019 | 133.79 | 91.9 | 106.24 |
| 51 | 52.6 | 13.1 | 0.0 | 14.2 | 0.0 | 0.0 | 17.5 | 0.6 | 0.0 | 0.014 | 157.55 | 93.5 | 111.2 |
| 52 | 0.0 | 53.2 | 0.0 | 0.0 | 10.5 | 0.0 | 17.7 | 0.6 | 0.0 | 0.014 | 161.65 | 95.3 | 113.57 |
| 53 | 33.5 | 11.2 | 99.0 | 12.0 | 0.0 | 0.0 | 14.8 | 0.5 | 0.0 | 0.012 | 158.6 | 96.1 | 113.17 |
| 54 | 31.1 | 10.4 | 92.0 | 0.0 | 8.2 | 0.0 | 13.8 | 0.5 | 0.0 | 0.011 | 134.07 | 93.2 | 107.92 |
| 55 | 40.8 | 13.6 | 120.5 | 0.0 | 0.0 | 26.4 | 18.1 | 0.6 | 0.0 | 0.014 | 142.27 | 93.9 | 108.84 |
| 55R | 42.1 | 14.0 | 124.5 | 0.0 | 0.0 | 6.8 | 18.6 | 0.7 | 0.0 | 0.015 | 137.75 | 93.4 | 102.69 |
| 56 | 47.5 | 15.8 | 0.0 | 0.0 | 0.0 | 30.8 | 21.1 | 0.7 | 0.0 | 0.017 | 137 | 90.7 | 105.95 |
| 56R | 60.3 | 20.1 | 0.0 | 0.0 | 0.0 | 9.8 | 26.7 | 0.9 | 0.0 | 0.021 | 158.17 | 93.6 | 110.2 |
| 57 | 24.0 | 8.0 | 0.0 | 8.6 | 0.0 | 0.0 | 10.6 | 0.0 | 0.83 | 0.008 | 158.14 | 94 | 111.56 |
| 58 | 20.1 | 6.7 | 59.5 | 7.2 | 0.0 | 0.0 | 8.9 | 0.0 | 0.51 | 0.007 | 157.77 | 95.5 | 112.34 |
| 59 | 25.6 | 8.5 | 37.8 | 9.2 | 0.0 | 0.0 | 11.3 | 0.0 | 0.72 | 0.009 | 158.45 | 95.3 | 112.44 |
| 60 | 20.7 | 6.9 | 15.3 | 7.4 | 0.0 | 0.0 | 9.2 | 0.0 | 0.63 | 0.007 | 159.1 | 94.8 | 112.18 |
| 61 | 0.0 | 52.3 | 0.0 | 14.1 | 0.0 | 0.0 | 17.4 | 0.6 | 0.0 | 0.014 | 166.99 | 95 | 114.07 |
| 62 | 0.0 | 43.6 | 0.0 | 5.9 | 0.0 | 0.0 | 14.5 | 0.5 | 0.0 | 0.012 | 165.35 | 94.6 | 112.67 |
| 63 | 0.0 | 51.7 | 0.0 | 3.5 | 0.0 | 0.0 | 17.2 | 0.6 | 0.0 | 0.014 | 160.91 | 94.2 | 110.56 |
| 64 | 32.7 | 10.9 | 0.0 | 5.9 | 0.0 | 0.0 | 14.5 | 0.5 | 0.0 | 0.012 | 158.15 | 93.7 | 111.64 |
| 65 | 15.4 | 5.1 | 5.7 | 2.8 | 0.0 | 0.0 | 5.1 | 0.0 | 0.54 | 0.005 | 162.93 | 94.8 | 111.86 |
| 66 | 29.7 | 9.9 | 8.1 | 5.3 | 0.0 | 0.0 | 9.9 | 0.0 | 0.90 | 0.010 | 163 | 94.8 | 111.9 |
| 67 | 8.0 | 23.9 | 8.8 | 4.3 | 0.0 | 0.0 | 7.9 | 0.0 | 0.71 | 0.008 | 162.33 | 95 | 111.56 |
| 68 | 0.0 | 73.7 | 0.0 | 19.9 | 0.0 | 0.0 | 49.0 | 1.7 | 0.0 | 0.039 | 168.61 | 95 | \grave{ } |

### Example 7

Table 6 shows a list of formulations using different ColorLok chemicals and different sizing agents. These formulations were used to determine the effect each chemical had on whiteness and brightness.

TABLE 6
Effect of Sizing Agents and Dye on Whiteness

| | ColorLok chemicals and different sizing agents | | | | | |
|---|---|---|---|---|---|---|
| | | OBA | Coat | | | |
| | | Hexa | Weight | | D65 | CIE |
| Cond # | | Wet #/t | gsm | TAPPI | Brightness | Whiteness |
| | Base Sheet | | NA | 92 | 102.01 | 138 |
| 4 | Hexa + Starch | 50 | 3.7 | 93 | 110 | 155 |
| 16-2 | Hexa + Starch + Calcium Chloride | 50 | 5.8 | 93 | 108 | 142 |
| 16 | Hexa + Starch + Calcium Chloride + | 50 | 5 | 92 | 110 | 139 |
| | SP AE76 | | | | | |
| 17 | Hexa + Starch + Calcium Chloride + | 50 | 4.1 | 92 | 107 | 139 |
| | SP AE29 | | | | | |
| 18 | Hexa + Starch + Calcium Chloride + | 50 | 4.5 | 92 | 108 | 140 |
| | SP AE32 | | | | | |
| 16d | Hexa + Starch + Calcium Chloride + | 50 | 4.7 | 93 | 108 | 146 |
| | SP AE76 + Dye | | | | | |
| 42 | Hexa + Starch + Calcium Chloride | 50 | 4.4 | 93.4 | 109 | 143 |
| 43 | Hexa + Starch + Calcium Chloride + | 50 | 4.6 | 92.7 | 108 | 141 |
| | SP 50 | | | | | |
| 44 | Hexa + Starch + Calcium Chloride + | 50 | 3.5 | 92.9 | 109 | 145 |
| | SP 50 + 1.5 ml dye | | | | | |
| 45 | Hexa + 110#/t Starch + Calcium | 50 | 3.7 | 93.7 | 109 | 148 |
| | Chloride + SP 50 + 1.5 ml Dye | | | | | |

The following observations were made for the coatings listed in Table 6: the base sheet was used as a control; condition 4 showed good compatibility with increased B and W; condition 16-2 (ColorLok formulation without size) showed increase in W compared to base, but lower than condition 4; conditions 16-18 showed no increase in W; condition 16d increased W 7 points compared to 16; condition 42 gave similar results to 16-2; condition 43 did not decrease W significantly compared to 42; conditions 44 and 45 increased W compared to 43.

Table 6 shows that when calcium chloride was added to Hexa and starch (16-2) the whiteness decreased 13 points from 155 to 142. That is, the main chemical for the ColorLok technology decreased whiteness significantly when added to the starch and the 3V OBA Hexa. When any of the sizing agents were added to the ColorLok formulation the whiteness also decreased. However, whiteness increased when dye was added to the formulation as in conditions 16d, 44, and 45. The data shows that the highest whiteness level was 148. All formulations listed in Table 6 had starch as one of the components and none of the formulations had PVOH.

### Example 8

Table 7 shows a list of formulations using different ColorLok chemicals and different OBAs. These formulations were used to determine the effect each OBA had on whiteness and brightness.

TABLE 7
Effect of Replacing 3V Hexa OBA with Clariant's Leucophor CE Tetra (Leu Ce) OBA

| Condition | | OBA | Coat | | D65 | CIE |
|---|---|---|---|---|---|---|
| # | Chemicals | wet #/t | Weight | TAPPI | Brightness | Whiteness |
| CONTROL | Hexa + Starch + Calcium | (HEXA | 5 | 92 | 110 | 139 |
| # 16 | Chloride + SP AE76 | OBA) | | | | |
| | | 50 | | | | |
| | | Leucophor | | | | |
| | | CE Tetra | | | | |
| | | Wet #/t | | | | |
| 19 | Leu Ce + Starch + Calcium | 21.8 | 3.8 | 93 | 108 | 146 |
| | Chloride + SP AE76 | | | | | |
| 19d | Leu Ce + Starch + Calcium | 21.8 | 4.5 | 92 | 108 | 152 |
| | Chloride + SP AE76 + Dye | | | | | |
| 20 | Leu Ce + Starch + Calcium | 21.8 | 4.8 | 93 | 108 | 146 |
| | Chloride + SP AP29 | | | | | |
| 21 | Leu Ce + Starch + Calcium | 21.8 | 4.7 | 93 | 108 | 147 |
| | Chloride + SP AE32 | | | | | |
| 21d | Leu Ce + Starch + Calcium | 21.8 | 4.2 | 93 | 108 | 154 |
| | Chloride + SP AE32 + Dye | | | | | |

The following observations were made for the coatings listed in Table 6: condition 16 from Table 6 was used as a control; condition 19 increased whiteness 7 points compared to 16; condition 19-d increased whiteness another 6 points compared to 19; conditions 20 and 21 showed similar whiteness to 19; and condition 21d increased whiteness compared to 21.

Table 7 shows that Clariant Leucophor CE Tetra increased the whiteness using less than half the amount of the 3V Hexa OBA. The addition of Dye also increased whiteness significantly. Condition 19d shows Leucophor and Dye increased the whiteness 13 points compared to the formulation currently used by the mill for high brightness ColorLok technology. This shows that B and W can be maintained with a reduction of 28 wet #/ton of OBA, if a tetra OBA is used.

This set of experiments shows that 3Vs Hexa OBA can be replaced with ClariantL Tetra OBA and increase whiteness. It also shows that addition of dye to the formulation increased the whiteness significantly. Although conditions 19d and 21d had the highest whiteness (152 and 154 respectively), these conditions failed to reach target whiteness of 157. All formulations in this set contained starch and none of them contained PVOH.

### Example 9

Table 8 show a list of coating formulations using PVOH in place of starch. These formulations were used to determine the effect PVOH had on whiteness and brightness.

TABLE 8
Effect of replacing Pearl Enzyme Modified Starch with PVOH

| | | OBA | | | | |
|---|---|---|---|---|---|---|
| Condition | | Hexa | Coat | | D65 | CIE |
| # | Chemicals | wet #/t | Weight | TAPPI | Brightness | Whiteness |
| Control | Hexa + Starch + Calcium | 50 | 5 | 92 | 110 | 139 |
| 16 | Chloride + SP AE76 | | | | | |
| 22 | Hexa + PVOH + Calcium | 50 | 4.3 | 95 | 114 | 166 |
| | Chloride + SP AE76 | | | | | |
| 22d | Hexa + PVOH + Calcium | 50 | 3 | 95 | 113 | 171 |
| | Chloride + SP AE76 + Dye | | | | | |
| 27 | Hexa + PVOH + Calcium | 50 | 3.1 | 95 | 114 | 166 |
| | Chloride | | | | | |
| 28 | Hexa + PVOH + Calcium | 50 | 2.1 | 94 | 114 | 165 |
| | Chloride + SP AE76 | | | | | |
| 29 | Hexa + PVOH + Calcium | 50 | 3.6 | 96 | 114 | 167 |
| | Chloride + SP AE76 + | | | | | |
| | ¼ dose Dye | | | | | |
| 30 | Hexa + 30#/t dose PVOH + | 50 | 4.1 | 96 | 114 | 165 |
| | Calcium Chloride + SP AE76 + | | | | | |
| | ¼ dose Dye | | | | | |
| 46 | Hexa + 15#/t PVOH + 45#/ton | 50 | 4.2 | 95 | 112 | 159 |
| | Starch + Calcium Chloride + | | | | | |
| | SPAE76 + ¼ dose Dye | | | | | |

The following observations were made for the coatings listed in Table 8: condition 16 from Table 6 was used as a control; conditions 22, 22d, 27 and 28 increased whiteness significantly compared to 16, and 22d was slightly blue; condition 29 retained high whiteness and eliminated slight blue color compared to 22d; condition 30 only showed a slight decrease in whiteness compared to 29; and condition 46 decreased whiteness compared to 30.

Table 8 shows the significant effect that replacing Pearl enzyme modified starch with PVOH had on whiteness. All the formulations in this set of experiments apart from the control (#16) had PVOH. The Table shows that the whiteness of all the conditions that contained PVOH was above 159.

Table 8 shows that by substituting PVOH for starch in the ColorLok formulation, it is possible to: 1) Achieve whiteness above 159; 2) Reduce whiteness loss due to sizing agent addition (conditions 27 vs. 28); and 3) Achieve high whiteness by mixing a lower dosage of PVOH mixed with starch (condition 46).

### Example 10

Table 9 shows a list of coating formulations using different OBA and using PVOH in place of starch. These formulations were used to determine the effect on whiteness and brightness.

TABLE 9
Combined Effect on Whiteness by Replacing 3V's Hexa
with 3V's Tetra OBA and Replacing Starch with PVOH

| | | 3V | 3V | | | | |
|---|---|---|---|---|---|---|---|
| Condition | | OBA | OBA | Coat | | D65 | CIE |
| # | Chemicals | Hexa | Tetra | Weight | TAPPI | Brightness | Whiteness |
| Control | 3V Hexa + Starch + Calcium | 50 | | 5 | 92 | 110 | 139 |
| 16 | Chloride + SP AE76 | | | | | | |
| 31 | 3V Tetra + Starch + Calcium | | 35 | 3.7 | 91 | 103 | 119 |
| | Chloride + SP AE76 | | | | | | |
| 32 | 3V Tetra + Starch + Calcium | | 35 | 3.5 | 90 | 104 | 123 |
| | Chloride + SP AE76 + | | | | | | |
| | 1.5 ml dye | | | | | | |
| 40 | 3V Tetra + PVOH + Calcium | | 35 | 3.1 | 95 | 114 | 166 |
| | Chloride | | | | | | |
| 41 | 3V Tetra + PVOH + Calcium | | 35 | 3.2 | 95 | 114 | 165 |
| | Chloride + SP AE76 | | | | | | |

The following observations were made for the coatings listed in Table 9: condition 16 from Table 6 was used as a control; conditions 31 and 32 decreased whiteness significantly compared to 16; and conditions 40 and 41 increased whiteness significantly compared to 16.

Table 9 shows formulations that contain 3Vs OBAs (Hexa and Tetra). 3Vs Tetra OBA is different from Leucophor CE Tetra OBA shown in Table 7. Condition #16 was the control and had 3Vs Hexa OBA. Conditions 31 and 32 show that when the 3Vs Hexa OBA was replaced with 3Vs Tetra OBA, the whiteness decreased significantly (well below the base paper whiteness) when the formulations contained starch. However, using 3Vs Tetra OBA and replacing the starch with PVOH (as in conditions 40 and 41) both brightness and whiteness was increased significantly.

From experiments in Tables 7 and 9, it shows that OBA tetra from different manufacturers had different effect on whiteness. Comparing condition #19 (Table 7) with condition #32 (Table 9), where the only difference with these formulations was the Tetra OBA manufacturer, the 146 whiteness of condition 19 (Clariant Tetra OBA) is considerably higher than the 123 whiteness of condition 32, i.e., 23 points higher whiteness was obtained by replacing the 3Vs Tetra with Clariants Tetra OBA and at a lower dosage.

### Example 11

Table 10 shows a list of coating formulations containing silica. These formulations were used to determine the effect on whiteness and brightness.

TABLE 10
Effect of Silica on Whiteness

| | | | | | | | | |
|---|---|---|---|---|---|---|---|---|
| | | Hexa | Tetra | Leuco | Coat | TAPPI | | |
| Cond | Chemicals | OBA | OBA | phor | Wt | B | D65B | CIE W |

Silica Base Conditions (using OBA Tetra (lower dosage) and starch

| | | | | | | |
|---|---|---|---|---|---|---|
| 38 | Silica + starch + dye + Tetra | 30 | 6.5 | 91.9 | 105 | 126 |
| | OBA + Calcium Chloride | | | | | |
| 39 | Silica + starch + dye + Tetra | 30 | 4.9* | 91.7 | 104 | 125 |
| | OBA + Calcium Chloride + SP | | | | | |
| | AE76 | | | | | |

Silica Based Conditions (using OBA Hexa (lower dosage than for
formulation without silica) and starch

| | | | | | | |
|---|---|---|---|---|---|---|
| 36 | Silica + starch + dye + Hexa + | 29 | 6.6 | 94.2 | 108 | 145 |
| | Calcium Chloride | | | | | |
| 37 | Silica + starch + dye + Hexa + | 29 | 6.5 | 94.2 | 109 | 145 |
| | Calcium Chloride + SP AE 76 | | | | | |

Silica Based Conditions (using Leucophor CE Tetra (less than
half dosage than the other OBA) and starch

| | | | | | | |
|---|---|---|---|---|---|---|
| 12a | Silica + ⅔ Starch + dye + Leu | 11 | 5.9 | 93 | 106 | 149 |
| | Ce + Calcium Chloride | | | | | |
| 12as | Silica + ⅔ Starch + dye + Leu | 11 | 5.6 | 93 | 106 | 149 |
| | Ce + Calcium Chloride + Size | | | | | |
| 11 | Silica + PVOH 24-203 + dye + | 11 | 4.3 | 96 | 112 | 164 |
| | Leu Ce | | | | | |
| 12 | Silica + PVOH 24-203 + dye + | 11 | 5.2 | 95 | 112 | 165 |
| | Leu Ce + Calcium Chloride | | | | | |
| 33 | Silica + PVOH 24-203 + dye + | 11 | 5.9 | 96.8 | 114 | 164 |
| | Leu Ce + Calcium Chloride | | | | | |
| 34 | Silica + PVOH + dye + Leu Ce + | 11 | 6 | 96.9 | 114 | 165 |
| | Calcium Chloride + SP AE 76 | | | | | |
| 35 | Silica + ½ dose PVOH + | 11 | 7.7 | 96.8 | 114 | 163 |
| | dye + Leu Ce + Calcium | | | | | |
| | Chloride + SP AE 76 | | | | | |

The following observations were made for the coatings listed in Table 10: conditions 37, 12 as and 34 showed no whiteness loss due to sizing, compared to 36, 12a and 33, respectively; condition 11 increased whiteness significantly compared to the starch containing coatings; and condition 35 maintained high whiteness with decreased PVOH.

When silica was mixed with PVOH the amount of OBA could be reduced significantly and high whiteness was achieved. Silica prevented whiteness loss due to sizing (comparing formulations 16-2 and 16 from Table 6 to 36 and 37 from Table 10).

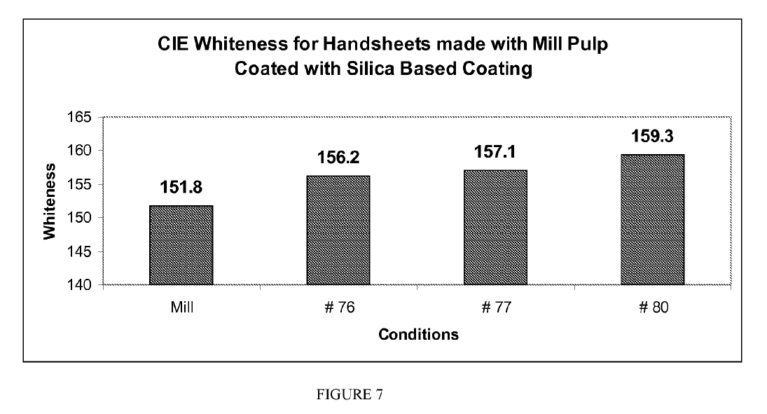

FIG. 7 shows four sets of handsheets coated with a silica based surface coating. The handsheets wet end chemicals are listed in Table 11. A review of FIG. 7 reveals that the surface chemicals increased the whiteness of the paper for conditions 77 and 80 and condition 76 followed closely. The Figure also shows that the mill condition had lower whiteness even with the silica based surface coating. This indicates that the base sheet can affect whiteness.

### Example 12

Tables 11(a) and (b) show a list of wet end formulations. These formulations were used to determine the effect on whiteness and brightness.

TABLE 11
(a): Handsheets Made with Different Wet End Chemicals and Sequences

| | | | | ASA/ | | | | | Eka | Eka | Eka | Eka | Eka | CIE | D65 | |
|---|---|---|---|---|---|---|---|---|---|---|---|---|---|---|---|---|
| Condition | PCC- | L- | PCC- | Stalok | | Dye- | Starch- | | PL | PL | NP | NP | NP | White- | Bright- | TAPPI |
| # | a | OBA | b | 400 | Alum | b | 1 | PAC | 1610 | 2510 | 320 | BMA-0 | 442 | ness | ness | B |
| 76 | 0 | 10 | 400 | 2 | 0 | 0 | 0 | 1 | 0 | 1 | 0 | 0 | 1 | 116 | 99 | 95 |
| 77 | 0 | 20 | 400 | 2 | 0 | 0 | 0 | 1 | 0 | 1 | 0 | 0 | 1 | 119 | 100 | 95 |
| 80 | 400 | 20 | 0 | 0 | 2 | 0.1 | 10 | 0 | 0.3 | 0 | 1.25 | 1.25 | 0 | 119 | 100 | 95 |

(b): Handsheet Made with Mill Wet End Chemicals and Sequences

| | | | | | | | | | Eka | CIE | D65 | |
|---|---|---|---|---|---|---|---|---|---|---|---|---|
| Condition | | | | | | Starch- | ACH- | EXP | NP | White- | Bright- | TAPPI |
| # | OBA | ACH | PCC | Alum | ASA | 1 | 2 | 1104 | 442 | ness | ness | B |
| Mill | 20 | 2 | 400 | 7.8 | 1.4 | 8 | 0.6 | 1.3 | 0.25 | 113 | 98 | 94 |

Tables 11(a) and (b) compares three wet end chemical sequences and the mill sequence. The results show that the mills wet end chemicals produced handsheets with lower whiteness and brightness than the other sequences of chemicals.

A review of Tables 11(a) and (b) reveals that the base sheet with the chemical sequences listed in Table 11(a) had better interaction with the surface chemicals for increased whiteness.

Based on the above examples, the inventors have found that there are several options for increasing whiteness by using surface additives, with significant factors for increasing whiteness for the ColorLok technology being the use of PVOH, blue pigment (dye), with or without the silica. However, if loss of whiteness due to sizing agent is an issue, silica can be used to prevent whiteness loss. Also, silica formulations require less OBAs, as the above examples show that silica balances the whiteness loss due to incompatibility of the OBA with other chemicals.

Thus, based on the above, the chemicals for the improvement of whiteness in the presence of calcium chloride are: PVOH, Dye (Premier Blue pigment or other), Silica and a combination of any two of them such as PVOH and Dye or Dye and Silica.

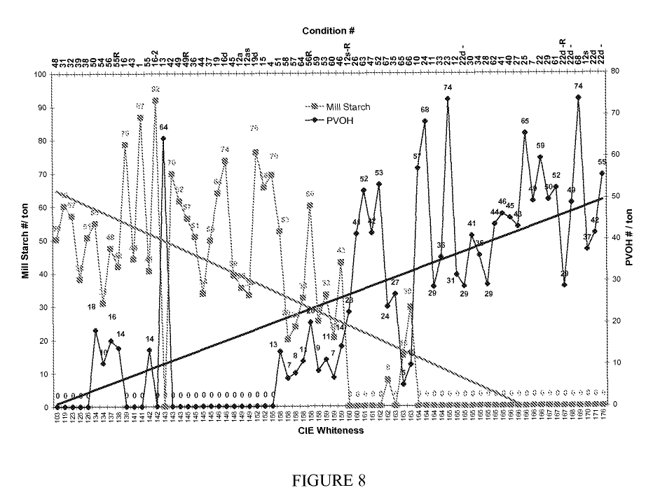

Further, from the experiments and results listed on Table 5, it can be concluded that the main chemical interaction that contributes to whiteness changes are starch and PVOH. FIG. 8 shows the trend for starch and PVOH. The Lower X axis shows whiteness in increasing order and it ranges from 109 to 176. The graph shows that as the starch levels are reduced to zero the whiteness increases and as the PVOH level increases from zero to 55 the whiteness increases. There is a small window where both the starch and PVOH overlap and where the whiteness is 158 to 159. The starch dosage varies from 20 to 45 and the PVOH from 7 to 15 (#/ton).

### Example 13

Experiments were run using a surface coating formulation, containing the components, if present, added in the following order: PVOH and Pigment premix, OBA, Starch, Sizing and Calcium Chloride. The amounts used were as follows: 4-5 lb/t Hexa OBA, 8 lb/t PVOH, 40-50 lb/t starch (treated with enzme), 1.0 to 1.25 lb/t SPAE76 (sizing), 0.02 lb/t XP3057 (blue pigment), and 20 lb/t Calcium Chloride, based on the dry weight of the paper.

The surface coating was coated on laser paper supplied by a southern U.S. mill. The results are listed in Tables 12 and 13.

TABLE 12
Results from Coating Experiments

| | Coating | | | | | XP | | | | | | | HP | HP |
|---|---|---|---|---|---|---|---|---|---|---|---|---|---|---|
| Model | Cond. | Sample | | | | 3057 | | | Speed | Coat | CIE | | Gamut | Gamut |
| Cond | # | # | Starch | OBA | Size | Pigment | PVOH | CaCl2 | (fpm) | weight | Whiteness | b* | Volume | Area |
| | | Paper | | | | | | | | | 155 | −15 | 173653 | 6514 |
| 1 | | Base | 0 | 0 | 0 | 0 | 0 | 0 | | 0 | 143 | −13 | 165690 | 6835 |
| 2 | 1 | 1 | 72 | 0 | 0.76 | 0.00 | 0 | 0 | 750 | 73 | 144 | −13 | 171005 | 6778 |
| 3 | 92 CL | 2 | 71 | 0 | 0.75 | 0.00 | 0 | 15 | 750 | 87 | 145 | −13 | 175191 | 6560 |
| 4 | 2 | 3 | 81 | 12 | 0.81 | 0.00 | 0 | 0 | 1000 | 94 | 157 | −16 | 163690 | 6634 |
| 5 | 96 CL | 4 | 68 | 12 | 0.68 | 0.00 | 0 | 14 | 750 | 94 | 153 | −15 | 169754 | 6352 |
| 6 | 3 | 5A | 29 | 4 | 0.73 | 0.02 | 1 | 15 | 900 | 50 | 155 | −15 | 172871 | 6473 |
| 7 | | 6 | 29 | 4 | 0.73 | 0.02 | 4 | 15 | 850 | 52 | 154 | −15 | 175731 | 6578 |
| 8 | | 7 | 31 | 4 | 0.77 | 0.02 | 5 | 15 | 850 | 56 | 155 | −15 | 176095 | 6619 |
| 9 | | 9 | 37 | 5 | 0.91 | 0.03 | 14 | 18 | 850 | 74 | 157 | −16 | 175510 | 6634 |
| 10 | 4 | 10 | 57 | 6 | 1.15 | 0.017 | 6 | 23 | 600 | 93 | 152 | −15 | 178374 | 6666 |
| 11 | | 11 | 61 | 5 | 1.02 | 0.015 | 5 | 20 | 600 | 93 | 151 | −14 | 178258 | 6692 |
| 12 | | 12 | 62 | 4 | 0.89 | 0.013 | 4 | 18 | 600 | 90 | 151 | −14 | 179465 | 6731 |
| 13 | 5 | 13A | 73 | 3 | 1.62 | 0.048 | 8 | 32 | 650 | 118 | 158 | −16 | 173939 | 6564 |
| 14 | | 13B | 57 | 3 | 1.27 | 0.038 | 6 | 25 | 650 | 93 | 155 | −15 | 177853 | 6701 |
| 15 | | 14 | 54 | 7 | 1.21 | 0.036 | 6 | 24 | 600 | 93 | 155 | −15 | 174018 | 6560 |
| 16 | | 15 | 52 | 11 | 1.15 | 0.034 | 6 | 23 | 600 | 93 | 157 | −16 | 169190 | 6365 |
| 17 | | 16 | 55 | 15 | 1.23 | 0.037 | 6 | 25 | 600 | 102 | 158 | −16 | 167533 | 6299 |
| 18 | 6 | 17 | 80 | 8 | 1.61 | 0.024 | 8 | 0 | 600 | 98 | 157 | −16 | 164482 | 6491 |
| 19 | | 18 | 90 | 7 | 1.49 | 0.022 | 7 | 0 | 600 | 106 | 157 | −16 | 167977 | 6602 |
| 20 | | 19 | 92 | 7 | 1.31 | 0.020 | 7 | 0 | 600 | 106 | 156 | −16 | 170504 | 6653 |
| 21 | 7 | 21 | 55 | 0 | 1.36 | 0.000 | 7 | 27 | 600 | 90 | 143 | −13 | 170881 | 6611 |
| 22 | | 22 | 52 | 0 | 1.29 | 0.013 | 6 | 26 | 600 | 85 | 145 | −13 | 177765 | 6679 |
| 23 | | 23 | 48 | 0 | 1.21 | 0.024 | 6 | 24 | 600 | 80 | 146 | −14 | 175552 | 6664 |
| 24 | | 24 | 59 | 0 | 1.48 | 0.022 | 7 | 30 | 600 | 98 | 145 | −13 | 177788 | 6702 |
| 25 | | 25 | 56 | 0 | 1.41 | 0.021 | 14 | 28 | 600 | 100 | 146 | −14 | 175865 | 6670 |
| 26 | | 26 | 56 | 0 | 1.41 | 0.021 | 21 | 28 | 600 | 107 | 147 | −14 | 177581 | 6753 |
| 27 | 8 | 27 | 70 | 0 | 1.41 | 0.021 | 7 | 28 | 600 | 107 | 145 | −13 | 177549 | 6717 |
| 28 | | 28 | 70 | 0 | 1.16 | 0.017 | 6 | 23 | 600 | 100 | 144 | −13 | 178813 | 6753 |
| 29 | | 29 | 73 | 0 | 1.04 | 0.016 | 5 | 21 | 600 | 100 | 142 | −13 | 180246 | 6788 |
| 30 | 9 | 30 | 101 | 0 | 2.53 | 0.038 | 5 | 0 | 600 | 109 | 147 | −14 | 167586 | 6690 |
| 31 | | 31 | 103 | 0 | 2.06 | 0.031 | 4 | 0 | 600 | 109 | 146 | −14 | 170278 | 6748 |
| 32 | | 32 | 104 | 0 | 1.73 | 0.026 | 3 | 0 | 600 | 109 | 146 | −14 | 171183 | 6792 |
| 33 | | 33 | 106 | 0 | 1.52 | 0.023 | 3 | 0 | 600 | 111 | 145 | −13 | 169725 | 6727 |

TABLE 13
Additional Results From Coating Experiments

| | | | | | | | | Sheffield | Sheffield | Taber |
|---|---|---|---|---|---|---|---|---|---|---|
| | | | | | | | | Roughness | Roughness | abrasion |
| | Canon | Canon | | | | | | Wire | Felt | mg/1000 revs |
| Model | Gamut | Gamut | TAPPI | D65 | | Tensile | Tensile | Lower is | Lower is | Lower is |
| Cond | Volume | Area | Brightness | Brightness | HST | MD | CD | better | better | better |
| | 103373 | 4790 | 95 | 111 | 103 | 5 | 2 | 149 | 165 | 43 |
| 1 | 127685 | 5617 | 93 | 105 | 7 | 4 | 2 | 140 | 167 | 169 |
| 2 | 116425 | 4815 | 92 | 104 | 27 | 5 | 2 | 194 | 169 | 57 |
| 3 | 121414 | 5305 | 92 | 105 | 30 | 5 | 2 | 178 | 168 | 56 |
| 4 | 124273 | 4996 | 93 | 111 | 10 | 5 | 2 | 132 | 133 | 36 |
| 5 | 122349 | 5221 | 93 | 110 | 13 | 5 | 2 | 198 | 175 | 54 |
| 6 | 125455 | 4904 | 93 | 108 | 8 | 4 | 2 | 171 | 137 | 69 |
| 7 | 109687 | 4896 | 93 | 108 | 4 | 5 | 2 | 136 | 121 | 64 |
| 8 | 121702 | 5078 | 93 | 108 | 4 | 5 | 2 | 220 | 190 | 64 |
| 9 | 130023 | 5138 | 93 | 109 | 3 | 5 | 2 | 213 | 165 | 52 |
| 10 | 132529 | 5239 | 93 | 108 | 3 | 5 | 2 | 178 | 165 | 57 |
| 11 | 131081 | 5147 | 93 | 108 | 3 | 5 | 2 | 159 | 143 | 44 |
| 12 | 135832 | 5340 | 93 | 108 | 3 | 5 | 2 | 163 | 140 | 41 |
| 13 | 123169 | 5314 | 93 | 108 | 4 | 5 | 2 | 175 | 154 | 38 |
| 14 | 114486 | 5095 | 92 | 108 | 3 | 5 | 2 | 175 | 154 | 39 |
| 15 | 134746 | 5299 | 93 | 109 | 3 | 5 | 2 | 167 | 178 | 47 |
| 16 | 125076 | 5075 | 93 | 110 | 5 | 5 | 2 | 153 | 158 | 34 |
| 17 | 130785 | 5210 | 93 | 110 | 3 | 5 | 2 | 204 | 164 | 33 |
| 18 | 124786 | 5154 | 93 | 108 | 5 | 6 | 3 | 162 | 129 | 45 |
| 19 | 131868 | 5444 | 93 | 108 | 5 | 6 | 3 | 133 | 148 | 48 |
| 20 | 131687 | 5402 | 93 | 108 | 6 | 6 | 3 | | | |
| 21 | 135799 | 5371 | 92 | 105 | 3 | 5 | 2 | 129 | 133 | 54 |
| 22 | 133920 | 5341 | 92 | 104 | 3 | 5 | 2 | 179 | 152 | 43 |
| 23 | 132766 | 5235 | 92 | 104 | 4 | 5 | 2 | 192 | 189 | 50 |
| 24 | 133984 | 5266 | 92 | 105 | 3 | 5 | 2 | 188 | 157 | 47 |
| 25 | 131231 | 5185 | 92 | 105 | 3 | 5 | 2 | 128 | 129 | 52 |
| 26 | 131605 | 5192 | 92 | 105 | 3 | 5 | 3 | 143 | 124 | 94 |
| 27 | 131945 | 5165 | 92 | 105 | 4 | 5 | 2 | 155 | 145 | 139 |
| 28 | 132271 | 5153 | 92 | 104 | 3 | 4 | 2 | 163 | 154 | 147 |
| 29 | 133665 | 5244 | 92 | 104 | 3 | 6 | 2 | 155 | 146 | 134 |
| 30 | 130145 | 5434 | 90 | 102 | 6 | 6 | 3 | 153 | 134 | 108 |
| 31 | 129299 | 5358 | 91 | 103 | 5 | 6 | 3 | 148 | 141 | 85 |
| 32 | 132574 | 5574 | 91 | 103 | 4 | 5 | 3 | 143 | 133 | 76 |
| 33 | 129414 | 5321 | 91 | 103 | 5 | 6 | 3 | 133 | 123 | 98 |

1. A method for making printing paper comprising preparing an ink receiving coating composition which comprises an optical brightening agent (OBA), polyvinyl alcohol (PVOH) and a water soluble divalent salt, wherein the PVOH and OBA are added to said composition prior to the salt, and applying said coating composition onto at least one surface of said paper.

2. A method according to claim 1, wherein the PVOH is added between the addition of the OBA and the salt or as a premix with the OBA.

3. A method according to claim 1, wherein the water soluble divalent salt is calcium chloride.

4. A method according to claim 1, wherein the PVOH is present in an amount effective to increase the whiteness of said printing paper by an amount of at least 20 CIE whiteness points, preferably at least 40 CIE whiteness points.

5. A method according to claim 1, wherein the OBA is a tetrasulfonate stilbene based OBA and the PVOH is present in an amount effective to prevent significant reduction in brightness of said printing paper with a 20 wt % reduction in the amount of OBA, preferably with a 30 wt % reduction in OBA.

6. A method according to claim 1, wherein said coating composition further comprises a dye.

7. A method according to claim 6, wherein the PVOH is premixed with either the OBA or dye prior to adding the PVOH to the coating composition.

8. A method according to claim 1, wherein said coating composition further comprises silica.

9. A method according to claim 8, wherein the silica is added to the coating composition prior to the OBA.

10. A method according to claim 1, wherein said coating composition further comprises starch and the ratio of PVOH to starch is at least 1:3, preferably at least 1:1, and the starch is present in an amount less than 27.5 kg/MT, preferably less than 15 kg/MT dry basis of paper suspension.

11. A method according to claim 8, wherein said coating composition further comprises a sizing agent.

12. A method according to claim 11, wherein the sizing agent is added to the coating composition after the salt.

13. A method according to claim 11, wherein the components of the coating composition are added to the coating composition in the following order relative to each other: silica, OBA, PVOH, salt and sizing agent.

14. A method according to claim 1, wherein said coating composition is applied to the paper surface in a size press.

15. A printing paper made by the method according to claim 1.

16. A paper surface coating composition providing improved paper whiteness comprising a protected optical brightening agent (OBA), protected by a polyvinyl alcohol (PVOH) component, and a water soluble divalent salt.

17. A coating composition according to claim 16, wherein the water soluble divalent salt is calcium chloride.

18. A coating composition according to claim 16, wherein said coating composition further comprises a dye.

19. A coating composition according to claim 16, wherein said coating composition further comprises silica.

20. A coating composition according to claim 19, wherein said coating composition further comprises sizing agent.
